(19) United States
(12) Patent Application Publication
(10) Pub. No.: US 2018/0293272 A1
(43) Pub. Date: Oct. 11, 2018

(54) Statistics-Based Multidimensional Data Cloning

(71) Applicant: Futurewei Technologies, Inc., Plano, TX (US)

(72) Inventors: Jiangsheng Yu, San Jose, CA (US); Shijun Ma, Milpitas, CA (US); Qingqing Zhou, Santa Clara, CA (US); Ting Yu Cliff Leung, San Jose, CA (US)

(21) Appl. No.: 15/479,843

(22) Filed: Apr. 5, 2017

(51) Int. Cl. G06F 17/30; G06F 17/16; G06F 17/18

(52) U.S. Cl. CPC G06F 17/30392; G06F 17/16; G06F 17/30365; G06F 17/30536; G06F 17/30598; G06F 17/18

(57) ABSTRACT

A method for cloning data samples in a data set based on statistic information of the data samples. The method does not use any of the data samples to perform the cloning. The statistic information includes a first set of statistic parameters obtained from a data matrix formed by data entries of the data samples based on Eckart-Young theorem, and a second set of statistic parameters indicating statistical properties of the data entries of the data samples. The data samples are reconstructed using the first and the second sets of statistic parameters based on Eckart-Young theorem.

### TECHNICAL FIELD

The present invention relates generally to data cloning, and in particular embodiments, to techniques and mechanisms for statistics-based multidimensional data cloning.

### BACKGROUND

Service providers, such as cellular network service providers, Internet service providers, or banking service providers, generally produce a large amount of user related data during the course of providing services to their customers. In many cases, the user related data includes sensitive information, such as security sensitive information or private information, and is not accessible or available to a third party. However, this kind of data is often very useful for applications that are based on the data or make use of the data. For example, a third party may want to use cell phone user related data to test a software application that is developed to provide online shopping service to cell phone users. In this case, it would be desirable to develop data cloning techniques that are capable of cloning the user related data so that the third party does not need to access the user related data itself.

### SUMMARY OF THE INVENTION

Technical advantages are generally achieved, by embodiments of this disclosure which describe statistics-based multidimensional data cloning.

According to one aspect of the present disclosure, there is provided a method that includes: obtaining, with one or more processors, statistic information of a first plurality of data samples in a data set, each of the first plurality of data samples comprising data entries corresponding to different entry categories, wherein the statistic information comprises a first set of statistic parameters obtained from a first data matrix formed by data entries of the first plurality of data samples based on Eckart-Young theorem, and the statistic information comprises a second set of statistic parameters indicating statistical properties of the data entries of the first plurality of data samples, wherein the statistic information excludes the first plurality of data samples in the data set; reconstructing, with one or more processors, the first plurality of data samples using the first set of statistic parameters and the second set of statistic parameters based on Eckart-Young theorem, whereby generating a second plurality of data samples, the second plurality of data samples comprising data entries corresponding to the different entry categories; and adjusting, with the one or more processors, the data entries of the second plurality of data samples based on corresponding entry categories so that the data entries of the second plurality of data samples satisfy requirements of the different entry categories.

Optionally, in any of the preceding aspects, the data set is a database comprising customer specific data.

Optionally, in any of the preceding aspects, the first plurality of data samples may be sampled from the data set with replacement.

Optionally, in any of the preceding aspects, the method further includes: reconstructing a part of the data set or the entire data set based on the second plurality of data samples.

Optionally, in any of the preceding aspects, the first set of statistic parameters comprises matrices obtained from singular value decomposition of the first data matrix based on Eckart-Young theorem.

Optionally, in any of the preceding aspects, the second set of statistic parameters may include maximal values and/or minimal values of the data entries of the first plurality of data samples corresponding to the different entry categories.

Optionally, in any of the preceding aspects, reconstructing the first plurality of data samples includes: calculating a second data matrix using the first set of statistic parameters based on Eckart-Young theorem; and reconstructing the first plurality of data samples using the second data matrix and the second set of statistic parameters.

Optionally, in any of the preceding aspects, the second data matrix is a matrix that is normalized using the second set of statistic parameters.

Optionally, in any of the preceding aspects, reconstructing the first plurality of data samples using the second data matrix and the second set of statistic parameters includes calculating a third matrix by using Aₚdiag(νₘₐₓ−νₘᵢₙ)+1ₙνₘᵢₙ^{T}, wherein Aₚ represents the second data matrix which has a size of n*d, diag(·) represents a diagonal matrix, νₘₐₓ=(max(a₁), . . . , max(aⱼ), . . . , max(a_{d})), νₘᵢₙ=(min(a₁), . . . , min(aⱼ), . . . , min(a_{d})), max(·) represents a maximal value, min(·) represents a maximal value, 1ₙ is a n*1 vector, and a₁, . . . , aⱼ, . . . , a_{d} are columns of the first data matrix which has a size of n*d, and wherein the second set of statistic parameters comprises νₘₐₓ and νₘᵢₙ.

Optionally, in any of the preceding aspects, the method further includes outputting the second plurality of data samples to an application, the application being configured to utilize data samples in the data set to generate a result.

Optionally, in any of the preceding aspects, the method further includes determining performance of an application using the second plurality of data samples, the application being configured to operate with the data set.

Optionally, in any of the preceding aspects, the method further includes detecting an error of an application using the second plurality of data samples, the application being configured to operate with the data set.

According to another aspect of the present disclosure, there is provided a non-transitory computer-readable media storing computer instructions for reconstructing data samples, that when executed by one or more processors, cause the one or more processors to perform the steps of: obtaining statistic information of a first plurality of data samples in a data set, each of the first plurality of data samples comprising data entries corresponding to different entry categories, wherein the statistic information comprises a first set of statistic parameters obtained from a first data matrix formed by data entries of the first plurality of data samples based on Eckart-Young theorem, and the statistic information comprises a second set of statistic parameters indicating statistical properties of the data entries of the first plurality of data samples, wherein the statistic information excludes the first plurality of data samples in the data set; reconstructing the first plurality of data samples using the first set of statistic parameters and the second set of statistic parameters based on Eckart-Young theorem, whereby generating a second plurality of data samples, the second plurality of data samples comprising data entries corresponding to the different entry categories; and adjusting the data entries of the second plurality of data samples based on corresponding entry categories so that the data entries of the second plurality of data samples satisfy requirements of the different entry categories.

Optionally, in any of the preceding aspects, the first plurality of data samples are sampled from the data set with replacement.

Optionally, in any of the preceding aspects, the computer instructions cause the one or more processors to further reconstruct a part of the data set or the entire data set based on the second plurality of data samples.

Optionally, in any of the preceding aspects, the first set of statistic parameters comprises matrices obtained from singular value decomposition of the first data matrix based on Eckart-Young theorem.

Optionally, in any of the preceding aspects, the second set of statistic parameters comprises maximal values of the data entries of the first plurality of data samples corresponding to the different entry categories, and minimal values of the data entries of the first plurality of data samples corresponding to the different entry categories.

Optionally, in any of the preceding aspects, reconstructing the first plurality of data samples comprises: calculating a second data matrix using the first set of statistic parameters based on Eckart-Young theorem; and reconstructing the first plurality of data samples using the second data matrix and the second set of statistic parameters.

Optionally, in any of the preceding aspects, reconstructing the first plurality of data samples using the second data matrix and the second set of statistic parameters comprises calculating a third matrix by using Aₚdiag(νₘₐₓ−νₘᵢₙ)+1ₙνₘᵢₙ^{T}, wherein Aₚ represents the second data matrix which has a size of n*d, diag(·) represents a diagonal matrix, νₘₐₓ=(max(a₁), . . . , max(aⱼ), . . . , max(a_{d})), νₘᵢₙ=(min(a₁), . . . , min(aⱼ), . . . , min(a_{d})), max(·) represents a maximal value, min(·) represents a maximal value, 1ₙ is a n*1 vector, and a₁, . . . , aⱼ, . . . , a_{d} are columns of the first data matrix which has a size of n*d, and wherein the second set of statistic parameters comprises νₘₐₓ and νₘᵢₙ.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a flowchart of an embodiment data cloning method;

FIG. 2 illustrates a flowchart of an embodiment method for producing statistic information of data samples;

FIG. 3 illustrates a flowchart of an embodiment method for data cloning based on statistic information;

FIG. 4 illustrates a diagram of an embodiment data cloning system;

FIG. 5 illustrates a flowchart of another embodiment data cloning method; and

FIG. 6 illustrates a block diagram of an embodiment processing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Embodiments of the present disclosure provide a method for data cloning. The embodiments of the present disclosure reconstruct data samples of a data set based on statistic information of the data samples. Each of the data samples may include data entries corresponding to different entry categories. The embodiments do not use any of the data samples themselves, and do not need to access the data samples, thus protecting security of the data samples and the data set.

In some embodiments, the statistic information of the data samples may include a first set of statistic parameters that are calculated using a matrix approximation technique from a sample matrix formed by data entries of the data samples. For example, the first set of statistic parameters may include Eckart-Young statistics that are calculated based on Eckart-Young theorem. In some embodiments, the statistic information may also include a second set of statistic parameters that indicate or represent statistical properties of the data entries of the sample matrix.

In some embodiments, the method may receive the statistic information, and reconstruct the data samples using the first set of statistic parameters and the second set of statistic parameters based on Eckart-Young theorem, thereby generating a second plurality of data samples. The second plurality of data samples include data entries corresponding to the different entry categories. The method may also adjust the data entries of the second plurality of data samples based on corresponding entry categories so that the data entries of the second plurality of data samples satisfy requirements of the different entry categories.

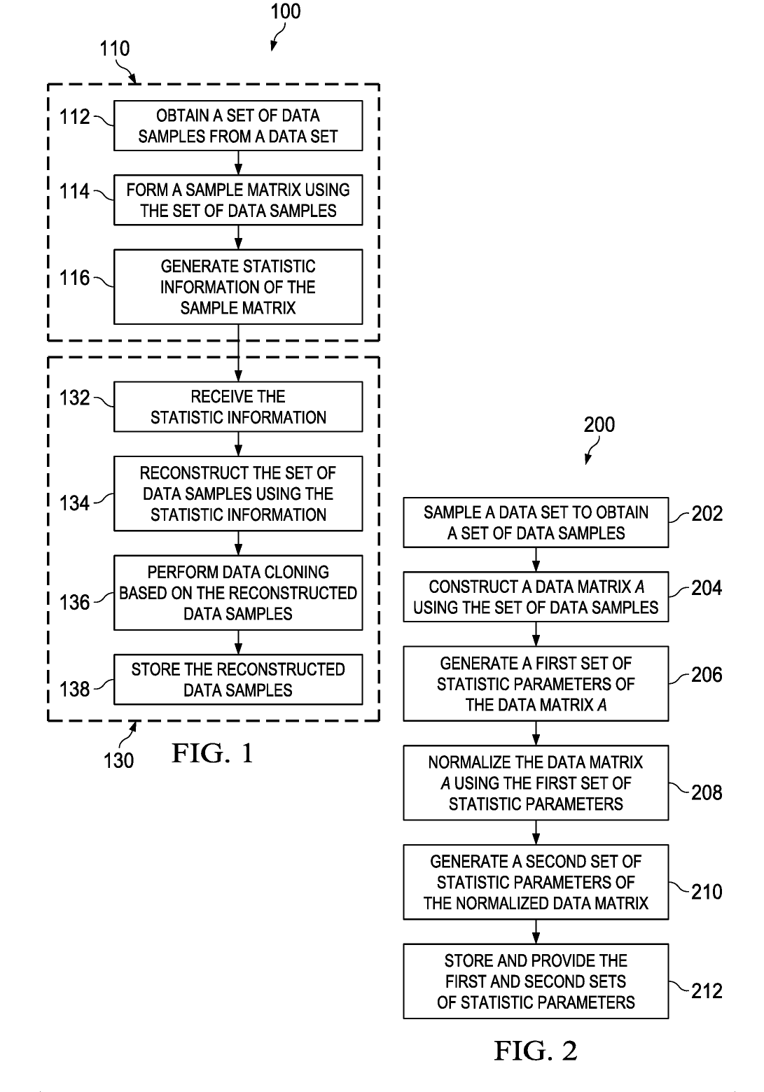

FIG. 1 illustrates a flowchart of an embodiment data cloning method 100. The method 100 clones a set of data samples in a data set based on statistic information of the set of data samples, without the need of using any of the set of data samples or the data set. The statistic information of the set of data samples may be generated by a data provider 110. The data provider 110 may be an owner of the data set, or another party who is authorized to generate the statistic information by accessing the data set. A third party 130 may obtain the statistic information and perform data cloning based on the statistic information to reconstruct the set of data samples.

In one embodiment, as shown in FIG. 1, the data provider 110 may first obtain the set of data samples from the data set at step 112. The data set may include a large amount of data samples arranged in a specific way so that the set of data samples can be selected from the data set. Examples of the data set include bank user databases, cell phone user databases, or medical insurance user databases. Each data sample may include multiple data entries corresponding to different entry categories or fields. Table 1 shows example data samples of a bank user database. Table 1 shows five data samples of the bank user database corresponding to five users. Each sample includes six data entries corresponding to entry categories or fields of “user name”, “age”, “gender”, “job title”, “income”, and “balance”. For example, sample number 1 corresponds to a user named “Ni”, who is at “age 1”, and has a gender “G1”, a job title “Title 1”, an income “income 1” and a balance “B1”. These data samples, as shown in Table 1, may be viewed as including multidimensional data because each data sample has multiple data entries corresponding to different categories. Data entries corresponding to different categories for a data sample may be independent from one another or may have latent relationships with one another. For example, it has been shown statistically that a user's income may be related to the user's gender and/or the user's income. These relationships may not be explicit, but are kept, statistically and latently, in the data entries and may represent important features of the data samples. It would be appreciated if these latent relationships can be kept in data that is reconstructed by data cloning.

TABLE 1

| Sample | User | | | Job | | |
|---|---|---|---|---|---|---|
| No. | Name | Age | Gender | Title | Income | Balance |
| 1 | N 1 | Age 1 | G 1 | Title 1 | Income 1 | B 1 |
| 2 | N 2 | Age 2 | G 2 | Title 2 | Income 2 | B 2 |
| 3 | N 3 | Age 3 | G 3 | Title 3 | Income 3 | B 3 |
| 4 | N 4 | Age 4 | G 4 | Title 4 | Income 4 | B 4 |
| 5 | N 5 | Age 5 | G 5 | Title 5 | Income 5 | B 5 |

The data provider 110 may select the set of data samples from the data set randomly or according to a predefined criterion. In one embodiment, the data provider 110 may obtain the set of data samples by sampling data samples from the data set with replacement. For example, a first data sample may be picked from the data set and recorded, and then the data sample is put back to the data set, where a second data sample is subsequently picked from the data set. The number of data samples sampled from the data set may be predetermined and may also be adjusted based on factors such as data amount in the data set, and other specific requirements, such as time, cost, and storage space.

At step 114, a sample matrix is formed using the set of data samples. For example, if the data samples in Table 1 above are used as the set of data samples, a sample matrix may be formed as shown in the following:

$$( \begin{matrix}N 1 & A 1 & G 1 & T 1 & I 1 & B 1 \\ N 2 & A 2 & G 2 & T 2 & I 2 & B 2 \\ N 3 & A 3 & G 3 & T 3 & I 3 & B 3 \\ N 4 & A 4 & G 4 & T 4 & I 4 & B 4 \\ N 5 & A 5 & G 5 & T 5 & I 5 & B 5\end{matrix} )$$

In this sample matrix, each row corresponds to a data sample, and each column corresponds to data entries corresponding to a category. In this example, data entries A1-A5 in the second column represent ages of users N1-N5, data entries T1-T2 in the fourth column represent job titles of users N1-N5, and data entries 11-15 in the fifth column represent incomes of N1-N5. When a data entry is not a numeral number, such as a name or job title, the data entry may be converted into a number and then used to form the sample matrix. For example, a user name “Jon” may be converted into a number using an index of “Jon” in a set of names. Those of ordinary skill in the art would recognize many ways to represent a text or other form of representations, such as time or currency, with numbers, or convert different forms of representations into numbers. Thus, data entries in the first column of the sample matrix correspond to numeral representations of the user names “N 1”, . . . and “N 5”, respectively. Similarly, data entries in the third and fourth columns correspond to numeral representations of genders and job titles of the users.

At step 116, statistic information of the sample matrix, i.e., the set of data samples, is generated. What kind of statistic information is to be generated may be predefined. A third party, such as the third party 130, may also require what kind of statistic information is produced. The third party may negotiate with the data provider 110 regarding what kind of statistic information the data provider 110 may provide. Determination of the statistic information to be generated may be based on many factors such as the ability of the data provider in producing the statistic information, cost, number of data samples, and types of customers related of the data samples. Generally, the statistic information should be able to be used to reconstruct the sample matrix without using any of the data samples. In one embodiment, the statistic information may include a first set of statistic parameters that are calculated from the sample matrix using a matrix approximation technique. In this case, the first set of statistic parameters may be referred to as matrix approximation statistics. For example, the first set of statistic parameters may be calculated based on Eckart-Young theorem. In this example, the first set of statistic parameters may be referred to as Eckart-Young statistics. Other applicable matrix approximation methods may also be used so as to approximate and reconstruct the sample matrix. In one embodiment, the matrix approximation statistics may be generated based on a normalized matrix of the sample matrix. The statistic information may also include a second set of statistic parameters that indicate or represent statistical properties of the data entries of the sample matrix. For example, the second set of statistic parameters may include maximum values of the data entries of the sample matrix. The second set of statistic parameters may also include minimum values, mean values, deviation values of the data entries. The second set of statistic parameters may be referred to as property statistics. The second set of statistic parameters is useful to provide statistical property information of the data entries when reconstructing the sample matrix. Based on the statistic information that is required, different techniques or mechanisms may be used for generating the statistic information.

The statistic information may then be provided to the third party 130 who performs data cloning using the statistic information. The statistic information may also be stored in a storage device or a database, and retrieved in future for use. The data provider 110 may generate different statistic information based on different techniques or mechanisms to accommodate different requirements of third parties.

When the third party 130 receives the statistic information at step 132, the third party 130 may reconstruct or clone the set of data samples, at step 134, using the statistic information according to the techniques or mechanisms that generate the statistic information. For example, when the statistic information is generated using Eckart-Young theorem, the third party 130 may use the statistic information to reconstruct a data matrix according to Eckart-Young theorem. In one embodiment, the first set of statistic parameters may be used to approximate the sample matrix, and the second set of statistic parameters may be used to reconstruct the approximated sample matrix so that the approximated sample matrix keep the statistical properties of the original sample matrix. The reconstructed data matrix includes reconstructed data samples. Further data cloning may also be performed, at step 136, based on the reconstructed data sample to clone more data samples in the data set, or clone the entirety of the data set.

At step 138, the reconstructed or cloned data samples are stored in a storage device or a database for use. The reconstructed or cloned data samples may be provided for use by applications which are configured to work with the data set. In one embodiment, the reconstructed data samples may be used for data analysis, and may produce useful information about user behaviors and other statistics in a specific service area. For example, the reconstructed data samples may be output to or retrieved by an application that performs analysis on reconstructed bank user data samples. The application produces charts or graphs, such as bar charts and pie charts, to show statistics of the users. In another embodiment, the reconstructed data samples may be used to determine performance or effectiveness of an application that is developed to operate on the data set. In yet another embodiment, the reconstructed data samples may be used to detect errors of an application that is configured to operate on the data set. The reconstructed data samples may also be used in many other applications, such as data mining, machine learning, query optimization of databases, and AB testing in market and business intelligence.

FIG. 2 illustrates a flowchart of an embodiment method 200 for producing statistic information of a set of data samples in a data set. The method 200 may be performed by the data provider 110 in FIG. 1. As shown, at step 202, the method 200 samples the data set to obtain a set of data samples. The data set may be sampled with replacement. The data set may also be sampled using other applicable sampling or selecting techniques. By sampling the data set, n data samples may be obtained. The n data samples are represented by X₁, X₂, . . . , Xₙ. Each of the data sample includes d data entries of corresponding data categories. At least two data categories may be different than each other. The n data samples may include data samples as shown in Table 1 above. The i-th data sample may be represented by Xᵢ=(Xᵢ⁽¹⁾,Xᵢ⁽²⁾, . . . , Xᵢ^{(d)}).

At step 204, the method 200 constructs a data matrix A using the n data samples. The data matrix is represented by:

$$A = {( \begin{matrix}{X}_{1}^{( 1 )} & {X}_{1}^{( 2 )} & … & {X}_{1}^{( d )} \\ ⋮ & ⋮ & ⋮ & ⋮ \\ {X}_{i}^{( 1 )} & {X}_{i}^{( 2 )} & … & {X}_{i}^{( d )} \\ ⋮ & ⋮ & ⋮ & ⋮ \\ {X}_{n}^{( 1 )} & {X}_{n}^{( 2 )} & … & {X}_{n}^{( d )}\end{matrix} )}_{n \times d} \qquad ( 1 )$$

The data matrix A may also be represented by A=(X₁, X₂, . . . , Xₙ)^{T}, where (·)^{T} represents transpose of a matrix. As discussed above, before constructing the data matrix A, each data entry of the n data samples, if not a numeral number, may be converted into or represented by a numeral number. The method 200 may then generate statistic information of the data matrix A.

At step 206, the method 200 generates a first set of statistic parameters, i.e., property statistics, of the data matrix A. In this example, the method 200 calculates a maximum value and a minimum value for each column of the data matrix A. Let data matrix A be represented by A=(a₁, . . . aⱼ, . . . a_{d}), where aⱼ is the j-th column vector of data matrix A. A maximum value and a minimum value of aⱼ are denoted by max (aⱼ) and min (aⱼ), respectively. Then the first set of statistic parameters will include a first vector νₘₐₓ=(max(a₁), . . . , max(aⱼ), . . . , max(a_{d})), and a second vector νₘᵢₙ=(min(a₁), . . . , min(aⱼ), . . . , min(a_{d})). Vectors νₘₐₓ and νₘᵢₙ represent the maximum values and minimum values for columns of the data matrix A.

At step 208, the method 200 normalizes the data matrix A using the first set of statistic parameters, i.e., νₘₐₓ and νₘᵢₙ. In one embodiment, the data matrix A may be normalized using the following equation:

$${A}^{′} = ( \frac{{a}_{1} - min ( {a}_{1} )}{max ( {a}_{1} ) - min ( {a}_{1} )} , … \frac{{a}_{j} - min ( {a}_{j} )}{max ( {a}_{j} ) - min ( {a}_{j} )} , … \frac{{a}_{d} - min ( {a}_{d} )}{max ( {a}_{d} ) - min ( {a}_{d} )} ) \qquad ( 2 )$$

where A′ is the normalized data matrix of A. With the normalization, all the entries in matrix A′ are in a closed interval [0, 1]. If a maximum value of a column is equal to a minimum of the column, each data entry of the column may be set to have a value of 1.

At step 210, the method 200 generates a second set of statistic parameters. In this example, the method 200 generates the second set of statistic parameters according to Eckart-Young theorem. Let r be the rank of the data matrix A, i.e., r=rank(A). According to Eckart-Young theorem, there exists orthonormal matrices U_{n×r} and V_{d×r}, and a diagonal matrix Σ=diag(σ₁, . . . σᵣ) for a matrix, e.g., the data matrix A or the normalized data matrix A′ (both are a n*d matrix), such that the data matrix A may be represented by:

A_{n×d}=UΣV^{T} (3)

and there is another matrix A, that can be represented by:

Aₚ=UₚΣₚVₚ^{T} (4)

In Equation (4), Uₚ, Σₚ and Vₚ are matrices that are formed by the firstp columns of the orthonormal matrices U_{n×r} and V_{d×r} and the diagonal matrix Σ, respectively. p is an integer. p may be a predefined integer satisfying 1≤p≤rank(A). P may also be the smallest integer that satisfies:

$$\frac{{‖ A - {A}_{p} ‖}_{F}}{{‖ A ‖}_{F}} = \sqrt{\frac{{σ}_{p + 1}^{2} + … + {σ}_{r}^{2}}{{σ}_{1}^{2} + … + {σ}_{r}^{2}}} \leq t$$

where t∈(0,1) is a given threshold of a relative error. t may be a predefined value, e.g., t=5%. ∥·∥_{F} represents a Frobenius norm of a matrix.

The orthonormal matrices U_{n×r} and V_{d×r} and the diagonal matrix Σ may be calculated by computing singular value decomposition (SVD) of A. Aₚ in Equation (4) is referred to as the p-th Eckart-Young approximation to matrix A. According to Eckart-Young theorem, A, is the optimal approximation to A in all matrices with rank p that satisfies

$${min}_{rank ( B ) = p} {‖ A - B ‖}_{F} = {‖ A - {A}_{p} ‖}_{F} = \sqrt{{\sum }_{i = p + 1}^{r} {σ}_{i}^{2}} .$$

In one embodiment, the method 200 performs SVD of the normalized data matrix A′ and obtains the corresponding orthonormal matrices U and V, and the diagonal matrix Σ. The method 200 may then obtain Uₚ, Σₚ and Vₚ from the matrices U, Σ and V based on Eckart-Young theorem. The Uₚ, Σₚ and Vₚ may be referred to as Eckart-Young statistic parameters. By using the Eckart-Young statistic parameters, an optimal approximation of the normalized data matrix A′ may be obtained.

At step 212, after generating the first and second sets of statistic parameters, i.e., the maximum vector νₘₐₓ, the minimum vector νₘᵢₙ and the Eckart-Young statistic parameters Uₚ, Σₚ and Vₚ, the method 200 stores the statistic parameters and provides the statistic parameters to other parties. The method 200 may store the statistic parameters locally, e.g., in a computer memory, or remotely, e.g., in a server. The method 200 may output or sent the statistic parameters to an application which is configured to use the statistic parameters. The method 200 may also output a signal indicating that the statistic parameters are generated, stored or delivered.

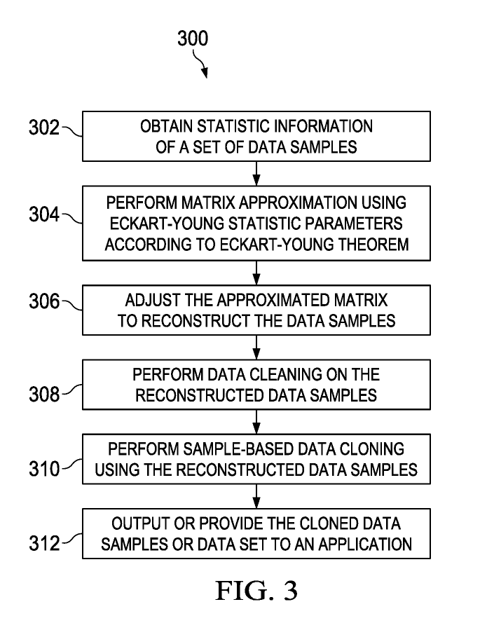

FIG. 3 illustrates a flowchart of an embodiment method 300 for data cloning based on statistic information. The method 300 performs data cloning based on statistic information of a set of data samples in a data set to reconstruct the set of data samples. The statistic information does not include and does not disclose any actual data of the data samples. A party performing the data cloning does not need to access the actual data of the data samples. Thus privacy and security of the data set is preserved.

As shown, at step 302, the method 300 obtains or receives the statistic information of the set of data samples. In this example, the statistic information includes the first and second sets of statistic parameters generated in FIG. 2. That is, the statistic information includes maximum vector νₘₐₓ, minimum vector νₘᵢₙ, and Eckart-Young statistic parameters Uₚ, Σₚ and Vₚ of the set of data samples.

The method 300 then reconstructs the set of data samples using the statistic information. In this example, at step 304, the method 300 first performs matrix approximation using the Eckart-Young statistic parameters according to Eckart-Young theorem. As result, the method 300 obtains an approximated matrix of the normalized data matrix A′. The approximated matrix is calculated according to Equation (4), i.e., Aₚ=UₚΣₚVₚ^{T}.

At step 306, the method 300 adjusts the approximated matrix to reconstruct the data samples using the maximum vector νₘₐₓ and the minimum vector νₘᵢₙ. In one embodiment, the approximated matrix may be adjusted using Aₚ′=Aₚdiag(νₘₐₓ−νₘᵢₙ)+1ₙνₘᵢₙ^{T}, where Aₚ′ is an adjusted matrix, 1ₙ is an n*1 vector, and

$$diag ( {v}_{1} , … , {v}_{d} ) = ( \begin{matrix}{v}_{1} & & \\ & ⋱ & \\ & & {v}_{d}\end{matrix} ) .$$

Each row of matrix A; represents a reconstructed data sample, and each column in a row represents a reconstructed data entry corresponding to an entry category. By adjusting the approximated matrix using the maximum vector νₘₐₓ and the minimum vector νₘᵢₙ, the adjusted matrix, consequently, the reconstructed data samples, keep the statistical properties conveyed by the statistical parameters νₘₐₓ and νₘᵢₙ.

At step 308, the method 300 may perform data cleaning on the matrix Aₚ′. The data cleaning is generally used to adjust values of the data entries in the matrix Aₚ′, such that the cloned data samples represent the original data samples in a meaningful manner. In one embodiment, the data cleaning is performed to adjust data entries in the matrix Aₚ′ according to data entry requirements of corresponding entry categories. For example, an entry category may require that data entries corresponding to the entry category have a specific data type, e.g., the data entries are integers. In another example, an entry category may require that data entries be in a specific data format, e.g., data entries corresponding to a date are in a format of yy/dd/yyyy. Different entry categories may have different requirements on the corresponding data entries. Reconstructed data samples may be adjusted according to the requirements to satisfy the requirements. For example, if a column of the matrix Aₚ′ corresponds to an entry category requiring an integer value, such as an age, data entries in this column, if not integers, may be adjusted to be integers, e.g., adjusted to the nearest integers. The method 300 may check data entries of the matrix Aₚ′ and determine whether a data entry needs to be adjusted according to a requirement.

At step 310, the method 300 may perform further data cloning to reconstruct more data samples using the reconstructed data samples represented by matrix Aₚ′ which has been cleaned. In one embodiment, the data cloning may be performed using a sample-based data cloning technique. Other applicable data cloning techniques may also be employed to perform data cloning based on the cleaned matrix Aₚ′. In this way, a partial of or the entirety of the data set may be cloned. At step 312, the method 300 may output or provide the cloned data samples or data set to an application that makes use of the cloned data for a specific purpose. For example, the application may use the cloned data to perform data analysis, data training, to determine performance of the application, and to debug the application. The method 300 may also output a signal indicating that the data cloning is performed and cloned data samples are ready for use.

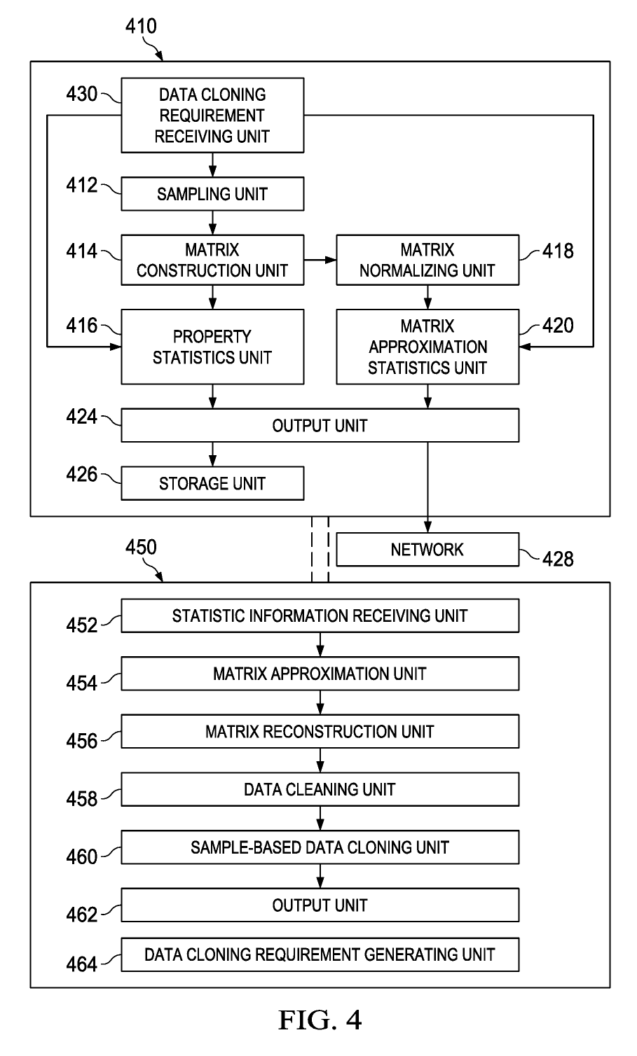

FIG. 4 illustrates a diagram of an embodiment data cloning system 400. The data cloning system 400 includes a statistic information generating unit 410 and a data cloning unit 450. The statistic information generating unit 410 is configured to generate statistic information of data samples for data cloning. The statistic information generating unit 410 may be configured to produce statistic information using the method illustrated in FIG. 2. The data cloning unit 450 is configured to perform data cloning based on the statistic information so that the data samples are reconstructed. The data cloning unit 450 may be configured to perform data cloning using the method illustrated in FIG. 3. The data cloning unit 450 may interact with the statistic information generating unit 410. For example, data cloning unit 450 may communicate with the statistic information generating unit 410 for receiving generated statistic information, or for communicating data cloning requirements. FIG. 4 will be described in the following with reference to FIG. 2 and FIG. 3.

As shown, the statistic information generating unit 410 includes a sampling unit 412, a matrix construction unit 414, a property statistics unit 416, a matrix normalizing unit 418, a matrix approximation statistics unit 420, an output unit 424, and a data cloning requirement receiving unit 430.

The sampling unit 412 is configured to sample a data set to obtain a set of data samples. Each data sample includes a set of data entries corresponding to entry categories. The sampling unit 412 may be configured to perform the step 202 in FIG. 2. The sampling unit 412 may sample the data set with replacement, or using other applicable sampling or selecting techniques. The matrix construction unit 414 is configured to construct a data matrix using the set of data samples obtained by the sampling unit 412. The matrix construction unit 414 may be configured to perform the step 204 in FIG. 2. In one embodiment, each data entry of the set of data samples, if not a numeral number, may be converted into or represented by a numeral number for forming the data matrix. The property statistics unit 416 is configured to generate a set of property statistics of the data matrix that represent statistical properties of the data matrix. In one example, the property statistics unit 416 may be configured to perform the step 206 in FIG. 2. The property statistics may include maximum values, minimum values, mean values, and other statistics of a matrix.

The matrix normalizing unit 418 is configured to perform normalization of the constructed data matrix. The matrix normalizing unit 418 may be configured to perform the normalization using one or more of the property statistics generated by the property statistics unit 416. One or ordinary skill in the art would recognize that any normalizing methods or techniques that are applicable may be used to normalize the data matrix. The matrix normalizing unit 418 may be configured to perform the step 208 in FIG. 2. The matrix approximation statistics unit 420 is configured to generate matrix approximation statistics of a normalized matrix generated by the matrix normalizing unit 418 using a matrix approximation technique. In one embodiment, the matrix approximation statistics unit 420 may generate Eckart-Young statistics of the normalized matrix according to Eckart-Young theorem. The matrix approximation statistics unit 420 may also use other applicable matrix approximation methods or techniques. The matrix approximation statistics unit 420 may be configured to perform the step 210 in FIG. 2.

The output unit 424 is configured to output the generated statistic information of the set of data samples, e.g., the property statistics and the matrix approximation statistics. In one embodiment, the output unit 424 may be configured to store the generated statistic information in a storage unit 426. The storage unit 426 may be a local storage device, such as a memory in a computing device. Alternatively, the output unit 424 may store the generated statistic information in a remote storage unit (not shown) accessed via a network 428. The output unit 424 may also be configured to output the generated statistic information to a device or an application, e.g., via the network 428. The output unit 424 may perform the step 212 in FIG. 2.

The data cloning requirement receiving unit 430 is configured to receive requirements for generating the statistic information. The requirements may indicate the statistic information that is to be generated. For example, the requirements may indicate what property statistics and what matrix approximation statistics are to be generated. The requirements may indicate that more than one type of statistic information is required to be generated. For example, the requirements may indicate that different matrix approximation statistics are to be produced based on different matrix approximation techniques. In another example, the requirements may indicate that different property statistics are to be produced in conjunction with different matrix approximation statistics. The requirements may also include a number of data samples to be used, sampling methods, matrix normalizing methods, and other information that may be needed for generating the statistic information. The data cloning requirement receiving unit 430 may interact with the sampling unit 412, property statistics unit 416 and matrix approximation statistics unit 420.

As also shown in FIG. 4, the data cloning unit 450 includes a statistic information receiving unit 452, a matrix approximation unit 454, a matrix reconstruction unit 456, a data cleaning unit 458, a sample-based data cloning unit 460, an output unit 462, and a data cloning requirement generating unit 464.

The statistic information receiving unit 452 is configured to receive statistic information of a set of data samples for performing data cloning of the set of data samples. The statistic information receiving unit 452 may retrieve the statistic information from a local or remotely accessed storage device. The statistic information receiving unit 452 may be configured to perform the step 302 in FIG. 3. The matrix approximation unit 454 is configured to perform matrix approximation using received matrix approximation statistics. The matrix approximation unit 454 may be configured to perform the step 304 in FIG. 3. For example, the matrix approximation unit 454 performs matrix using Eckart-Young theorem. The matrix reconstruction unit 456 is configured to reconstruct the data samples using an approximated matrix generated by the matrix approximation unit 454 and received property statistics of the data sample. The matrix reconstruction unit 456 may be configured to perform the step 306 in FIG. 3. The data cleaning unit 458 is configured to perform data cleaning of the reconstructed data samples. In one embodiment, the data cleaning unit 458 adjusts data entries of the reconstructed data samples so that they have values that satisfy requirements of entry categories corresponding to the data entries. The data cleaning unit 458 may be configured to perform the step 308 in FIG. 3.

The sample-based data cloning unit 460 is configured to perform further data cloning using the cleaned reconstructed data samples to produce more cloned data samples. The sample-based data cloning unit 460 may be configured to perform the step 310 in FIG. 3. The output unit 462 is configured to output or provide cloned data, e.g., to an application, or a storage device. The output unit 462 may be configured to perform the step 312 in FIG. 3. The data cloning requirement generating unit 464 is configured to generate requirements for producing the statistic information used in data cloning. These requirements may be sent to the statistic information generating unit 410. The requirements may indicate what property statistics and what matrix approximation statistics are to be generated. The requirements may require different types of statistic information to be generated. For example, the requirements may indicate that different matrix approximation statistics are to be produced based on different matrix approximation techniques. In another example, the requirements may indicate that different property statistics are to be produced in conjunction with different matrix approximation statistics. The requirements may also include a number of data samples to be used, sampling methods, matrix normalizing methods, matrix approximation techniques, and other information that may be needed for generating the statistic information.

Embodiment methods of the present disclosure have many advantages over conventional methods, such as methods that use histogram, correlation coefficients, multivariate density estimation, etc. The embodiment methods do not need real data samples, and no real samples are disclosed to the third party for data cloning. The data matrix is approximated by using a few well-defined statistics, such as maximum values, minimum values, and Eckart-Young statistics, without using any actual data of the data samples to be cloned, and the approximation is controlled by a given bound of a relative error, e.g., the relative error threshold t. Thus, the embodiment methods do not need to access the data samples and data security is protected. The embodiment methods also have benefits to explore and clone latent statistical relationships between data entries. This helps preserve latent features of the original data samples in the cloned data samples. The embodiment methods does not have requirements on distributions of the data set or data samples to be cloned, and does not have requirements on data type of the data set. For example, the embodiment methods are operable on data sets having any combination of continuous data (i.e., data with continuous values, e.g., income, bank balance) and discrete (i.e., data with discrete values, e.g., age, gender). Moreover, the embodiment methods may be implemented in a parallelizable manner. Many steps involved may be implemented in parallel. For example, generation of statistic information, reconstruction of data samples and sample-based data cloning may be performed in parallel. Normalization of the data matrix, calculation of SVD, matrix approximation using Eckart-Young theorem, and data cloning each may also be performed using parallel algorithms. The embodiment methods provide a different approach to estimation problems beyond the conventional bootstrapping method, and have wide-spread applications, such as statistics analysis, big data analysis, machine learning, data mining, and artificial intelligence. The embodiment methods are also useful in various simulation scenarios, including query optimization in database, AB testing in market and business intelligence, data analysis without security risk, etc.

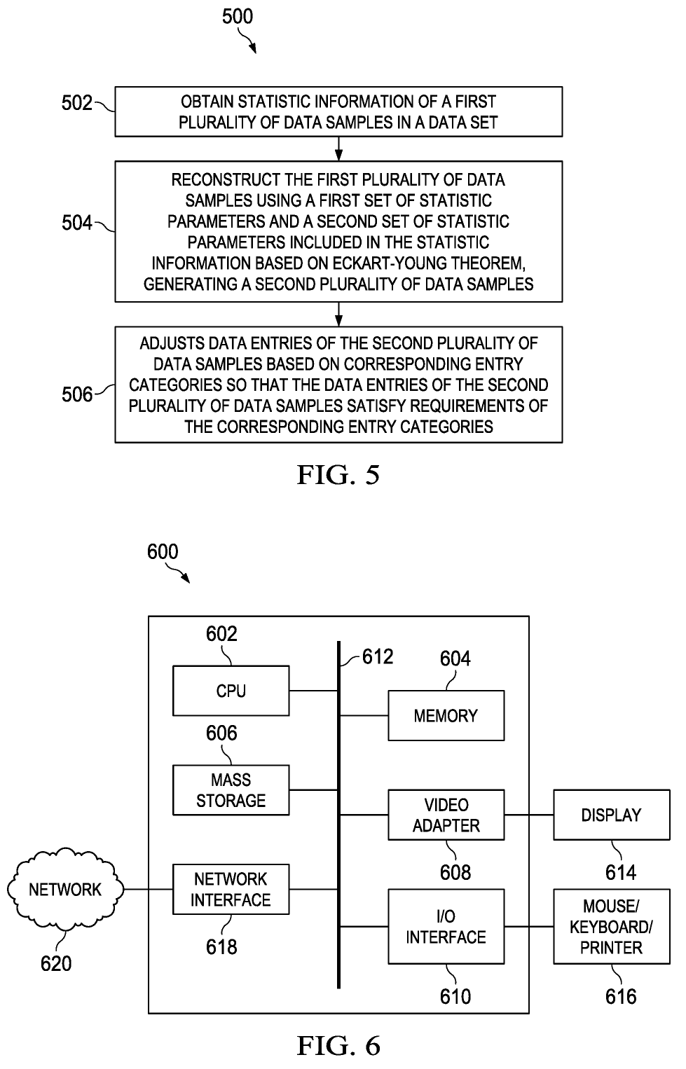

FIG. 5 illustrates a flowchart of another embodiment method 500 for data cloning. The method 500 may be a computer-implemented method executed with one or more processors. At step 502, the method 500 obtains statistic information of a first plurality of data samples in a data set. Each of the first plurality of data samples includes data entries corresponding to different entry categories. The statistic information may include a first set of statistic parameters obtained from a first data matrix formed by data entries of the first plurality of data samples based on Eckart-Young theorem, and a second set of statistic parameters indicating statistical properties of the data entries of the first plurality of data samples. The statistic information excludes the first plurality of data samples in the data set. The data set may be a database including customer specific data.

The first plurality of data samples may be sampled from the data set with replacement. The first set of statistic parameters comprises matrices obtained from singular value decomposition of the first data matrix based on Eckart-Young theorem. The second set of statistic parameters may include maximal values νₘₐₓ and/or minimal values νₘᵢₙ of the data entries of the first plurality of data samples corresponding to the different entry categories.

At step 504, the method 500 reconstructs the first plurality of data samples using the first set of statistic parameters and the second set of statistic parameters based on Eckart-Young theorem, generating a second plurality of data samples. The second plurality of data samples includes data entries corresponding to the different entry categories. In one embodiment, the method 500 may calculate a second data matrix using the first set of statistic parameters based on Eckart-Young theorem, and reconstruct the first plurality of data samples using the second data matrix and the second set of statistic parameters. The second data matrix may be a matrix that is normalized using the second set of statistic parameters. In another embodiment, the reconstructed first plurality of data samples may be a third matrix calculated using Aₚdiag(νₘₐₓ−νₘᵢₙ)+1ₙνₘᵢₙ^{T}, where Aₚ represents the second data matrix which has a size of n*d, diag(·) represents a diagonal matrix, and the second set of statistic parameters includes νₘₐₓ and νₘᵢₙ.

At step 506, the method 500 adjusts the data entries of the second plurality of data samples based on corresponding entry categories so that the data entries of the second plurality of data samples satisfy requirements of the different entry categories.

The method 500 may further reconstruct a part of the data set or the entire data set based on the second plurality of data samples. For example, after adjusting the data entries of the second plurality of data samples, the method 500 performs sample-based data cloning using the adjusted data entries. The method 500 may output the second plurality of data samples to an application that is configured to utilize or operate on the data samples in the data set. For example, the application may be configured to generate a result using the adjusted data entries. In another example, the application may be configured to use the adjusted second plurality of data samples to determine performance of the application. The method may further use the second plurality of data samples to detect an error of an application configured to operate with the data set.

FIG. 6 is a block diagram of a processing system 600 that may be used for implementing the methods disclosed herein. The processing system 600 may be implemented on a computing platform or a device. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 600 may comprise a processing unit equipped with one or more input/output devices, such as a speaker, microphone, mouse, touchscreen, keypad, keyboard, printer, display, and the like. The processing system 600 may include a central processing unit (CPU) 602, memory 604, a mass storage device 606, a video adapter 608, and an I/O interface 610 connected to a bus 612.

The bus 612 may be one or more of any type of several bus architectures including a memory bus or memory controller, a peripheral bus, video bus, or the like. The CPU 602 may comprise any type of electronic data processor. The memory 604 may comprise any type of non-transitory system memory such as static random access memory (SRAM), dynamic random access memory (DRAM), synchronous DRAM (SDRAM), read-only memory (ROM), a combination thereof, or the like. In an embodiment, the memory 604 may include ROM for use at boot-up, and DRAM for program and data storage for use while executing programs.

The mass storage device 606 may comprise any type of non-transitory storage device configured to store data, programs, and other information and to make the data, programs, and other information accessible via the bus. The mass storage device 606 may comprise, for example, one or more of a solid state drive, hard disk drive, a magnetic disk drive, an optical disk drive, or the like.

The video adapter 608 and the I/O interface 610 provide interfaces to couple external input and output devices to the processing system 600. As illustrated, examples of input and output devices include a display 614 coupled to the video adapter 608 and a mouse/keyboard/printer 616 coupled to the I/O interface 610. Other devices may also be coupled to the processing system 600, and additional or fewer interface cards may be utilized. For example, a serial interface such as Universal Serial Bus (USB) (not shown) may be used to provide an interface for a printer.

The processing system 600 also includes one or more network interfaces 618, which may comprise wired links, such as an Ethernet cable or the like, and/or wireless links to access nodes or different networks. The network interface 618 allows the processing system 600 to communicate with remote units via the networks. For example, the network interface 618 may provide wireless communication via one or more transmitters/transmit antennas and one or more receivers/receive antennas. In an embodiment, the processing system 600 is coupled to a network 620, such as a local-area network or a wide-area network, for data processing and communications with remote devices, such as other processing units, the Internet, remote storage facilities, or the like.

Embodiments of the disclosure may be performed as computer-implemented methods. The methods may be implemented in a form of software. In one embodiment, the software may be obtained and loaded into a computer or any other machines that can run the software. Alternatively, the software may be obtained through a physical medium or distribution system, including, for example, from a server owned by the software creator or from a server not owned but used by the software creator. The software may be stored on a server for distribution over the Internet. Embodiments of the disclosure may be implemented as instructions stored on a computer-readable storage device or media, which may be read and executed by at least one processor to perform the methods described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, solid state storage media, and other storage devices and media.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an obtaining unit/module, a reconstructing unit/module, an adjusting unit/module, a sampling unit/module, a calculating unit/module, a normalizing unit/module, an outputting unit/module, a determining unit/module, a detecting unit/module, a storing unit/module, a constructing unit/module, a performing unit/module, and/or a generating unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A computer-implemented method for data cloning, comprising:
obtaining, with one or more processors, statistic information of a first plurality of data samples in a data set, each of the first plurality of data samples comprising data entries corresponding to different entry categories, wherein the statistic information comprises a first set of statistic parameters obtained from a first data matrix formed by data entries of the first plurality of data samples based on Eckart-Young theorem, and the statistic information comprises a second set of statistic parameters indicating statistical properties of the data entries of the first plurality of data samples, wherein the statistic information excludes the first plurality of data samples in the data set;
reconstructing, with one or more processors, the first plurality of data samples using the first set of statistic parameters and the second set of statistic parameters based on Eckart-Young theorem, whereby generating a second plurality of data samples, the second plurality of data samples comprising data entries corresponding to the different entry categories; and
adjusting, with the one or more processors, the data entries of the second plurality of data samples based on corresponding entry categories so that the data entries of the second plurality of data samples satisfy requirements of the different entry categories.

2. The computer-implemented method of claim 1, wherein the data set is a database comprising customer specific data.

3. The computer-implemented method of claim 1, wherein the first plurality of data samples are sampled from the data set with replacement.

4. The computer-implemented method of claim 1, further comprising reconstructing a part of the data set or the entire data set based on the second plurality of data samples.

5. The computer-implemented method of claim 1, wherein the first set of statistic parameters comprises matrices obtained from singular value decomposition of the first data matrix based on Eckart-Young theorem.

6. The computer-implemented method of claim 1, wherein the second set of statistic parameters comprises maximal values of the data entries of the first plurality of data samples corresponding to the different entry categories.

7. The computer-implemented method of claim 1, wherein the second set of statistic parameters comprises minimal values of the data entries of the first plurality of data samples corresponding to the different entry categories.

8. The computer-implemented method of claim 1, wherein reconstructing the first plurality of data samples comprises:
calculating a second data matrix using the first set of statistic parameters based on Eckart-Young theorem; and
reconstructing the first plurality of data samples using the second data matrix and the second set of statistic parameters.

9. The computer-implemented method of claim 8, wherein the second data matrix is a matrix that is normalized using the second set of statistic parameters.

10. The computer-implemented method of claim 8, wherein reconstructing the first plurality of data samples using the second data matrix and the second set of statistic parameters comprises calculating a third matrix by using Aₚdiag(νₘₐₓ−νₘᵢₙ)+1ₙνₘᵢₙ^{T}, wherein Aₚ represents the second data matrix which has a size of n*d, diag(·) represents a diagonal matrix, νₘₐₓ=(max(a₁), . . . , max(aⱼ), . . . , max(a_{d})), νₘᵢₙ=(min(a₁), . . . , min(aⱼ), . . . , min(a_{d})), max(·) represents a maximal value, min(·) represents a maximal value, 1 is a n*1 vector, and a₁, . . . , aⱼ, . . . , a_{d} are columns of the first data matrix which has a size of n*d, and wherein the second set of statistic parameters comprises νₘₐₓ and νₘᵢₙ.

11. The computer-implemented method of claim 1, further comprising outputting the second plurality of data samples to an application, the application being configured to utilize data samples in the data set to generate a result.

12. The computer-implemented method of claim 1, further comprising determining performance of an application using the second plurality of data samples, the application being configured to operate with the data set.

13. The computer-implemented method of claim 1, further comprising detecting an error of an application using the second plurality of data samples, the application being configured to operate with the data set.

14. A non-transitory computer-readable media storing computer instructions for reconstructing data samples, that when executed by one or more processors, cause the one or more processors to perform the steps of:
obtaining statistic information of a first plurality of data samples in a data set, each of the first plurality of data samples comprising data entries corresponding to different entry categories, wherein the statistic information comprises a first set of statistic parameters obtained from a first data matrix formed by data entries of the first plurality of data samples based on Eckart-Young theorem, and the statistic information comprises a second set of statistic parameters indicating statistical properties of the data entries of the first plurality of data samples, wherein the statistic information excludes the first plurality of data samples in the data set;
reconstructing the first plurality of data samples using the first set of statistic parameters and the second set of statistic parameters based on Eckart-Young theorem, whereby generating a second plurality of data samples, the second plurality of data samples comprising data entries corresponding to the different entry categories; and
adjusting the data entries of the second plurality of data samples based on corresponding entry categories so that the data entries of the second plurality of data samples satisfy requirements of the different entry categories.

15. The non-transitory computer-readable media claim 14, wherein the first plurality of data samples are sampled from the data set with replacement.

16. The non-transitory computer-readable media of claim 14, wherein the computer instructions cause the one or more processors to further reconstruct a part of the data set or the entire data set based on the second plurality of data samples.

17. The non-transitory computer-readable media of claim 14, wherein the first set of statistic parameters comprises matrices obtained from singular value decomposition of the first data matrix based on Eckart-Young theorem.

18. The non-transitory computer-readable media of claim 14, wherein the second set of statistic parameters comprises maximal values of the data entries of the first plurality of data samples corresponding to the different entry categories, and minimal values of the data entries of the first plurality of data samples corresponding to the different entry categories.

19. The non-transitory computer-readable media of claim of claim 14, wherein reconstructing the first plurality of data samples comprises:
calculating a second data matrix using the first set of statistic parameters based on Eckart-Young theorem; and
reconstructing the first plurality of data samples using the second data matrix and the second set of statistic parameters.

20. The non-transitory computer-readable media of claim 19, wherein reconstructing the first plurality of data samples using the second data matrix and the second set of statistic parameters comprises calculating a third matrix by using Aₚdiag(νₘₐₓ−νₘᵢₙ)+1ₙνₘᵢₙ^{T}, wherein Aₚ represents the second data matrix which has a size of n*d, diag(·) represents a diagonal matrix, νₘₐₓ=(max(a₁), . . . , max(aⱼ), . . . , max(a_{d})), νₘᵢₙ=(min(a₁), . . . , min(aⱼ), . . . , min(a_{d})), max(·) represents a maximal value, min(·) represents a maximal value, 1ₙ is a n*1 vector, and a₁, . . . , aⱼ, . . . , a_{d} are columns of the first data matrix which has a size of n*d, and wherein the second set of statistic parameters comprises νₘₐₓ and νₘᵢₙ.
